(19) United States
(12) Patent Application Publication
(10) Pub. No.: US 2013/0076236 A1
(43) Pub. Date: Mar. 28, 2013

(54) DISPLAY APPARATUS

(71) Applicants: Takayuki Sumida, Kawasaki-shi (JP); Satoru Shiobara, Mobara-shi (JP); Koji Ishizuya, Chiba-shi (JP)

(72) Inventors: Takayuki Sumida, Kawasaki-shi (JP); Satoru Shiobara, Mobara-shi (JP); Koji Ishizuya, Chiba-shi (JP)

(73) Assignee: CANON KABUSHIKI KAISHA, Tokyo (JP)

(21) Appl. No.: 13/603,929

(22) Filed: Sep. 5, 2012

(30) Foreign Application Priority Data
Sep. 28, 2011 (JP) 2011-212117

(51) Int. Cl. H05B 33/14

(52) U.S. Cl. 313/504

(57) ABSTRACT

Provided is a display apparatus including an organic EL device in which blur in a displayed image to be a problem for the display apparatus is reduced. The display apparatus includes a plurality of subpixels for emitting light having different emission colors in a pixel, and each of the plurality of subpixels includes an organic EL device. A transparent layer having a refractive index higher than that of an organic compound layer of the organic EL device is provided on the organic EL device, and further, a light extraction structure surrounding each of the subpixels is provided on the transparent layer. A distance between the subpixels closest to each other included in two adjacent pixels is set to be at least a sum of waveguide lengths of light emitted from the respective subpixels.

### BACKGROUND OF THE INVENTION

1. Field of the Invention

The present invention relates to a display apparatus including an organic electroluminescence (EL) device, and more particularly, to a full-color display apparatus in which one pixel includes a plurality of subpixels having different emission colors.

2. Description of the Related Art

In recent years, organic light-emitting devices that emit light spontaneously with a low drive voltage of about several volts are drawing attention. The organic electroluminescence (EL) device utilizes its excellent features such as surface emitting characteristics, light weight, and visibility and is being put into practical use as a light-emitting apparatus of a thin display, a lighting equipment, a head-mounted display, or a light source for a printhead of an electrophotographic printer.

The organic EL device has structure in which an emission layer made of an organic material and a plurality of layers made of organic materials having separated functions are sandwiched between an anode and a cathode, and an electrode on at least one light exit side is transparent. Due to this stack structure, light traveling in a direction at a critical angle or larger in each interface determined by a refractive index of the emission layer, a medium on the light exit side, and a refractive index of air into which light is finally released is totally reflected to be confined as propagating light in the device. The propagating light is absorbed by organic compound layers and metal electrodes in the device and is not extracted out of the device, with the result that light extraction efficiency is lowered.

For improving the light extraction efficiency, there have been proposed a number of methods of changing a traveling direction of light to break the total reflection condition, such as a method of providing fine uneven structure or lens structure on the surface on the light exit side so as to extract the propagating light out of the device. In particular, as a method having high improvement effects, there has been proposed a method of providing a transparent layer, the refractive index of which is equal to or higher than that of an emission layer, adjacently to a light exit side of a transparent electrode, and further providing a region for causing disturbance in reflection/scattering angles of light on the light exit side of the transparent layer or in the transparent layer (Japanese Patent Application Laid-Open No. 2004-296429).

According to the above-mentioned method, based on the classical Snell's law, propagating light in the emission layer which occupies about 80% of the light emitted by the emission layer is pulled in a high-refractive-index transparent layer whose refractive index is higher than that of the emission layer to be converted into propagating light in the transparent layer. The propagating light thus obtained is extracted out of the device through the region for causing disturbance in reflection/scattering angles of light on the surface of the transparent layer or in the transparent layer.

However, when the method of causing light to propagate through the high-refractive-index transparent layer is applied to a display apparatus such as a display, a peculiar problem occurs. Light which is guided to the high-refractive-index transparent layer and is finally output to the air through the region for causing disturbance in reflection/scattering angles of light includes light traveling at an angle equal to or higher than a critical angle, which is originally supposed to be totally reflected. This light is recognized as light emitted from a position different from an actual light-emitting point due to parallax caused by the thickness of the high-refractive-index transparent layer, and hence, there arises a problem of blur in a displayed image. In order to solve this problem, there has been proposed a method of adjusting the thickness of a substrate (although not the high-refractive-index transparent layer), through which light propagates, to a predetermined proportion or less of a pixel size (Japanese Patent Application Laid-Open No. 2005-322490).

Further, when the light guided to the high-refractive-index transparent layer enters the region for causing disturbance in reflection/scattering angles, the light is not necessarily extracted to an air side through one incidence. Light whose traveling direction has been changed by the region for causing disturbance in reflection/scattering angles is also totally reflected again to propagate through the high-refractive-index transparent layer in the case where the light travels at an angle equal to or larger than a critical angle in an interface between the high-refractive-index transparent layer and the air. Consequently, the light propagates laterally through the high-refractive-index transparent layer and is eventually output to the air side at a position away from the light-emitting point at which the total reflection condition has been broken. Therefore, there still arises a problem of blur in a displayed image. In particular, as the refractive index of the transparent layer is higher, the amount of high-angle component light is larger, and hence, the number of times at which the light enters the region for causing disturbance in reflection/scattering angles decreases, and the waveguide length in the lateral direction up to the point where the light is extracted to the air side increases, which renders the problem more serious.

### SUMMARY OF THE INVENTION

It is an object of the present invention to reduce blur in a displayed image which is to be a problem for a display apparatus using an organic EL device, while efficiently extracting propagating light outside, which propagates through a transparent layer having a refractive index higher than that of an organic compound layer in the display apparatus.

A display apparatus of the present invention includes pixels which enable a larger amount of light to be extracted from an organic EL device by providing a light extraction structure on a high-refractive-index transparent layer having a refractive index higher than that of an organic compound layer adjacent to a transparent electrode on a light exit side of the organic EL device. The present inventors have paid attention to the waveguide length of light propagating laterally through the high-refractive-index transparent layer, and thereby accomplished the present invention.

That is, according to the present invention, there is provided a display apparatus, including a plurality of pixels each including a plurality of subpixels for emitting light having different emission colors, each of the plurality of subpixels including an organic EL device which includes a first electrode, a second electrode, and an organic compound layer including an emission layer disposed between the first electrode and the second electrode, in which: the organic EL device includes, on a light exit side thereof, a transparent layer having a refractive index higher than a refractive index of the organic compound layer; the transparent layer includes a light extraction structure provided outside of each of the plurality of subpixels; and a distance between subpixels closest to each other included in two adjacent pixels is set to be at least a sum of waveguide lengths of light emitted from the two subpixels closest to each other included in the two adjacent pixels.

According to the present invention, the display apparatus in which blur in a displayed image is reduced while light extraction efficiency is enhanced can be provided. The luminance increases in all directions due to the enhancement of the light extraction efficiency, and hence, a display apparatus with low power consumption can be provided.

Further features of the present invention will become apparent from the following description of exemplary embodiments with reference to the attached drawings.

### BRIEF DESCRIPTION OF THE DRAWINGS

FIGS. 1A and 1B are schematic top views each illustrating a planar layout of pixels in a display apparatus according to an embodiment of the present invention.

FIGS. 2A and 2B are views each schematically illustrating a planar layout of a light extraction structure of the display apparatus according to the embodiment of the present invention.

FIG. 3 is a schematic cross-sectional view taken along line 3-3 in FIG. 2B.

FIG. 4 is a schematic cross-sectional view of an organic EL device of a display apparatus according to the exemplary embodiment of the present invention.

FIG. 5 is an explanatory diagram of a waveguide length of light emission according to the present invention.

FIG. 6A is a schematic top view illustrating a configuration of a display apparatus according to another embodiment of the present invention and FIG. 6B is a schematic cross-sectional view taken along line 6B-6B in FIG. 6A.

### DESCRIPTION OF THE EMBODIMENTS

Preferred embodiments of the present invention will now be described in detail in accordance with the accompanying drawings.

An organic EL device includes a first electrode, a plurality of organic compound layers including an emission layer having a light-emitting region on the first electrode, and a second electrode. The organic EL device emits light through use of energy generated by the recombination of holes and electrons which are injected into the organic compound layers by application of a voltage across the first and second electrodes. One of the first and second electrodes is a reflective electrode, and the other is a transparent electrode. Further, one of the first and second electrodes is an anode, and the other is a cathode. In a display apparatus of the present invention, a reflective electrode is formed as the first electrode on a support substrate, and emitted light is extracted from a transparent electrode side. In the display apparatus of the present invention, in order to effectively extract light emitted in the organic EL device outside, a high-refractive-index transparent layer having a refractive index higher than those of the organic compound layers is provided adjacent to the transparent electrode, and further, a light extraction structure for extracting light is disposed adjacent to the high-refractive-index transparent layer. This configuration enables light from the emission layer to reach the light extraction structure without being totally reflected and to be effectively extracted outside.

In the present invention, the light extraction structure is not provided on a subpixel but is provided so as to surround an outer circumference of each subpixel.

The present invention has a feature that the distance between closest subpixels which belong to different pixels is equal to or larger than the sum of waveguide lengths of light emission of the subpixels. This can prevent blur in a displayed image, which is caused by color mixing of the adjacent pixels.

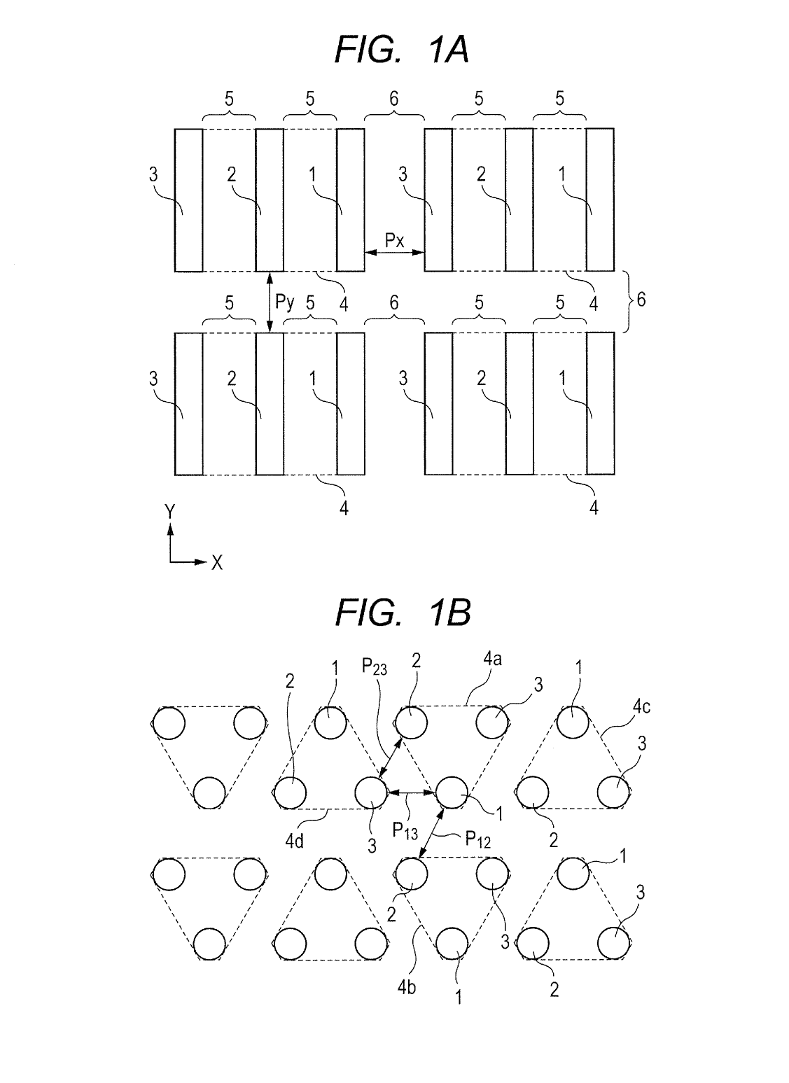

Hereinafter, the display apparatus of the present invention is described by way of an embodiment. FIG. 1A illustrates a planar layout of pixels in the display apparatus according to an embodiment of the present invention. In this embodiment, each pixel 4 includes subpixels 1, 2, and 3 which respectively emit lights of three primary colors (blue, green, and red). Here, the pixel 4 includes at least three subpixels 1, 2, and 3, and two inter-subpixel regions 5. An inter-pixel region 6 refers to a region between two adjacent pixels 4, and specifically, to a region between the subpixels 1 and 3 included in adjacent pixels, a region between the subpixels 1 and 1 included in adjacent pixels, a region between the subpixels 2 and 2 included in adjacent pixels, and a region between the subpixels 3 and 3 included in adjacent pixels. The distances of the inter-pixel region 6 in an X-direction and in a Y-direction are defined as Pₓ and P_{y}. Further, FIG. 1B illustrates another example of the planar layout of the pixels in the display apparatus according to an embodiment of the present invention, in which pixels are disposed in a triangular lattice shape. In this case, the distance between the subpixels can also be defined. For example, the distance between ends of the subpixels 1 and 2 on the central line thereof is defined as P₁₂. Similarly, the distance between the subpixels 1 and 3 is defined as P₁₃, and the distance between the subpixels 2 and 3 is defined as P₂₃. In the following description, the embodiment is described in detail based on the layout disposed in a triangular lattice shape.

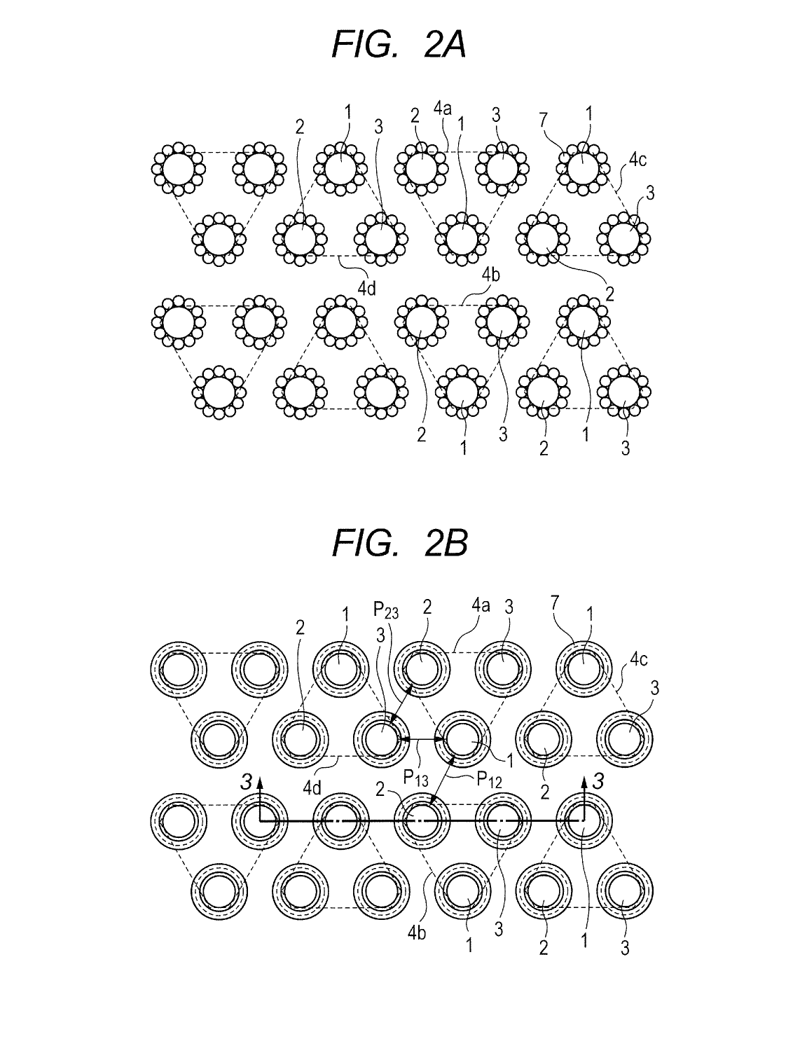

FIGS. 2A and 2B are views each illustrating a planar layout of light extraction structures 7 provided in the display apparatus of FIG. 1B. In the display apparatus of the present invention, as illustrated in FIGS. 2A and 2B, the light extraction structure 7 is not present on a light-emitting region of each of the subpixels 1, 2, and 3, but the light extraction structure 7 is provided so as to surround an outer circumference of each light-emitting region. The light extraction structure 7 may have a configuration in which a plurality of conical structures surround an outer circumference of each light-emitting region (subpixel) as illustrated in FIG. 2A or in which one ring-shaped structure obtained by integrating conical structures surrounds an outer circumference of the light-emitting region (subpixel) in a loop shape as illustrated in FIG. 2B.

In the display apparatus of the present invention, each light-emitting region of the subpixels 1, 2, and 3 is determined by the area of a patterned electrode (described later) which is formed on a support substrate side. In this case, the display apparatus has cross-sectional structure schematically illustrated in FIG. 3, and the electrode area of a reflective electrode 19 (described later) becomes the light-emitting region of each of the subpixels 1, 2, and 3.

Further, in the configuration of FIG. 3, although a bank 15 is provided so as to avoid interpixel crosstalks, a short circuit, and the disconnection of electrode wiring or to insulate a region between electrodes to limit a light-emitting region, the bank 15 may not be provided. In the case of FIG. 3, an opening provided in each subpixel by the bank 15 corresponds to each of the subpixels 1, 2, and 3 of FIGS. 1A and 1B.

The subpixels 1, 2, and 3 are formed of organic EL devices having respective emission colors. In FIG. 3, each organic EL device includes the reflective electrode 19 as the first electrode on a support substrate 9 and an organic compound layer 16, 17, or 18 on the reflective electrode 19, and further, includes a transparent electrode as the second electrode on a light exit side. The organic compound layers 16, 17, and 18 respectively have an emission layer for emitting light according to the emission color of each of the subpixels 1, 2, and 3. The transparent electrode 20 is formed continuously over the entire display region and has a high-refractive-index transparent layer 10 having a refractive index higher than those of the organic compound layers 16, 17, and 18. Further, the high-refractive-index transparent layer 10 includes the light extraction structures 7.

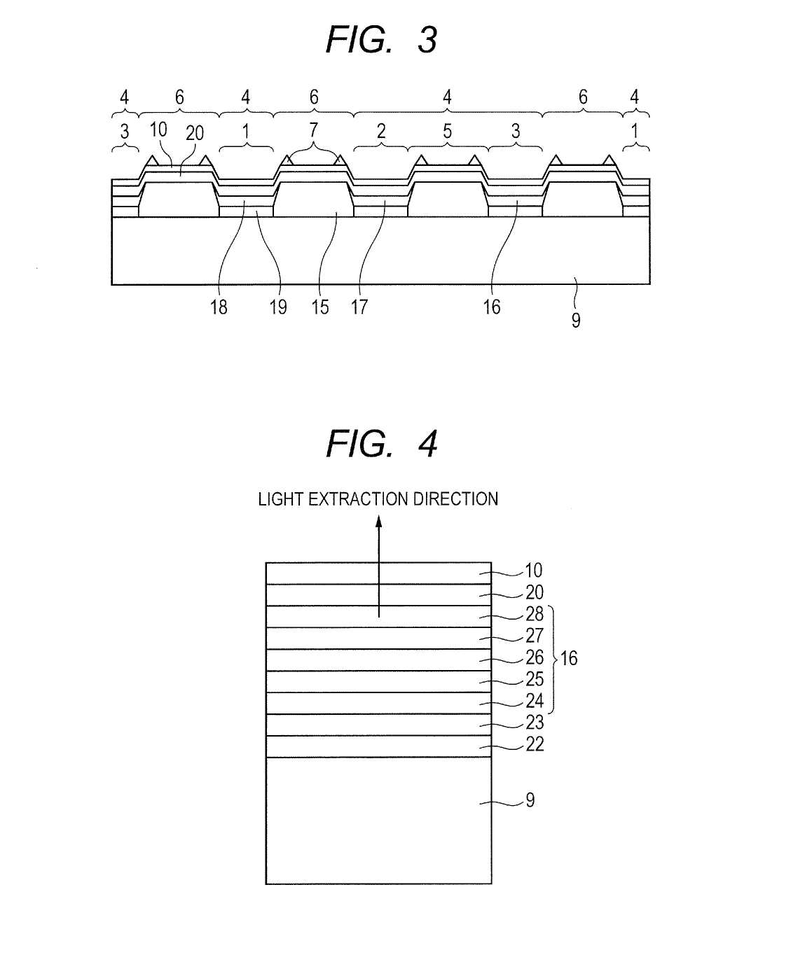

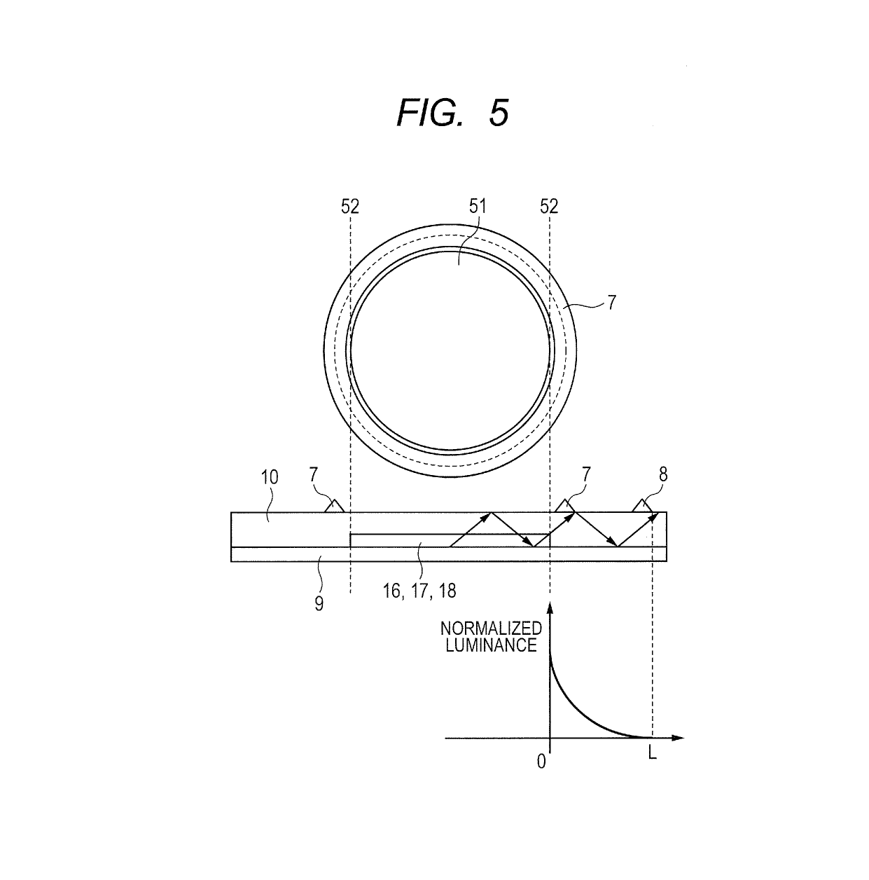

FIG. 4 illustrates a configuration example of the cross-sectional structure of the organic EL device used in each of the subpixels 1, 2, and 3. It is well known that a plurality of organic compound layers including an emission layer are present between a reflective electrode 22 and a transparent electrode 23 as the first electrode provided on the support substrate 9 and a transparent electrode 20 as the second electrode, and various stack configurations may be contemplated from viewpoints of emission efficiency, a driving lifetime, and optical interference. Note that, although only the reflective electrode 19 is illustrated as the first electrode in FIG. 3, the first electrode is formed of the reflective electrode 22 and the transparent electrode 23 in the configuration of FIG. 4, and any configuration may be applied to the present invention as long as the configuration is an electrode configuration having reflectivity.

FIG. 4 illustrates an exemplary configuration in which a hole injection layer 24, a hole transport layer 25, an emission layer 26, an electron transport layer 27, and an electron injection layer 28 are provided as the organic compound layer 16 (17 or 18) of FIG. 3. The present invention has no limitation on materials contained in each layer. For example, any one of a fluorescent material and a phosphorescent material can be used as a material constituting the emission layer 26, and at least one kind of compounds may be contained in the emission layer 26 in addition to a host material and a light-emitting material so as to enhance device performance. Further, the hole transport layer 25 may function as an electron block layer, and the electron transport layer 27 may function as a hole block layer.

By adjusting the film thickness between a light-emitting position of the emission layer 26 and a reflective surface of the reflective electrode 22 of the organic compound layer 16 (17 or 18), a light radiation distribution in the emission layer 26 can be controlled. In a display apparatus, by setting the film thickness of each organic compound layer so that the luminance becomes high particularly in the front direction, an emission color is also controlled by optical interference, and light is radiated in the front direction more efficiently. Specifically, by adjusting the optical distance from the light-emitting position of the emission layer 26 to an interface between the transparent electrode 21 and the reflective electrode 22 to be n/4 (n=1, 3, 5, . . . ) of an emission wavelength, front luminance in the light extraction direction from the emission layer 26 can be further enhanced.

In order to enhance the light extraction efficiency, it is preferred that the reflectivity of the reflective electrode 22 be higher. For example, as a material for the reflective electrode 22, a silver (Ag) electrode is more preferred than an aluminum (Al) electrode. As means for further enhancing the reflectivity, a procedure for stacking layers having different refractive indices as in a dielectric multi-layered film mirror may be used.

In the example of FIG. 4, emitted light is not confined in the device through use of the transparent electrode 20 as the second electrode, but light is extracted to the light extraction structure 7 without being confined or totally reflected by providing the high-refractive-index transparent layer 10 adjacently to the transparent electrode 20. Specifically, the total reflection occurring between the high-refractive-index transparent layer 10 and the air or another medium is avoided by providing the light extraction structure 7, and light in the device can be effectively extracted outside. Thus, the light extraction efficiency of the organic EL device, which is usually considered to be about 20%, is enhanced remarkably.

Further, a semi-transparent electrode of a metal thin film or the like may be used in place of the transparent electrode 20 of the second electrode. In this case, the reflectivity of the second electrode increases, with the result that the characteristics as an optical resonator are exhibited. However, a high-angle radiation optical component from the emission layer 26 is generated to some degree. Therefore, it may also be effective to use the semi-transparent electrode even though an increase in the light extraction efficiency through use of the semi-transparent electrode is smaller than that obtained by using the transparent electrode 20. This means that the effect does not particularly depend on whether or not the second electrode is transparent.

The high-refractive-index transparent layer 10 may be used as a barrier layer against the intrusion of gas such as water vapor or oxygen. In order for the high-refractive-index transparent layer 10 to function as a barrier layer, the film thickness thereof may be about several μm within a range of 0.5 μm or more and 6.0 μm or less, although it depends on a material to be used. The preferred film thickness also depends on the size of the light extraction structure 7, and hence, the film thickness does not need to be defined. It is not preferred that the film thickness of the high-refractive-index transparent layer 10 be 6.0 μm or more, because light easily propagates for a long distance in the high-refractive-index transparent layer 10, and the light is easily extracted from the light extraction structure 7 on an adjacent pixel 4. The film thickness of the high-refractive-index transparent layer 10 is more preferably 0.5 μm or more and 1.0 μm or less from a viewpoint of the enhancement of the light extraction efficiency.

Although the refractive indices of the organic compound layers 16, 17 and 18 vary depending on the material, the refractive index thereof is generally about 1.6 to 2.0 in a blue light-emitting region, about 1.5 to 1.9 in a green light-emitting region, and about 1.5 to 1.8 in a red light-emitting region. Thus, the high-refractive-index transparent layer 10 only needs to have a refractive index at least higher than those of the organic compound layers 16, 17, and 18 used in the organic EL devices in the respective blue, green, and red light-emitting regions.

Further, although a silicon nitride film (SiNₓ) which sufficiently functions also as a barrier layer is used as the high-refractive-index transparent layer 10, other materials such as titanium oxide and zinc oxide can be appropriately selected as long as the material satisfies the above-mentioned optical characteristics. No particular limitation is imposed on the element composition and element compositional ratio of the silicon nitride film, and other elements may be mixed with nitrogen and silicon as main components. As a film formation process for obtaining the silicon nitride film, chemical vapor deposition (CVD) is used. Although the optical constant of the silicon nitride film also varies depending on the film formation conditions such as a substrate temperature and a film formation speed, the silicon nitride film only needs to be a transparent layer having a refractive index higher than those of the organic compound layers 16, 17, and 18 in the present invention. The light transmittance of the high-refractive-index transparent layer 10 is preferably 85% or more, more preferably 90% or more in a visible light region.

The light extraction structure 7 according to the present invention may be formed by directly processing the high-refractive-index transparent layer 10. In the above-mentioned configuration, a method of producing organic compound layers, forming a high-refractive-index layer, and producing the light extraction structure 7 on the high-refractive-index transparent layer is described, but the following another method may be conducted. Specifically, by forming an intended shape (for example, a ring shape described later) similar to the light extraction structure 7 on the support substrate 9 in advance and successively forming the organic compound layers 16, 17, and 18 and the transparent electrode 20 on the light extraction structure 7, an organic film and a transparent electrode are formed in accordance with the shape. Consequently, structure having the effect equal to that in the case where the high-refractive-index transparent layer 10 having the intended shape is formed separately can be obtained eventually. This is because indium tin oxide (ITO) or indium zinc oxide (IZO) which is a general material as the transparent electrode 20 has a refractive index higher than those of the organic compound layers 16, 17, and 18. Specifically, the shape produced on the substrate in advance and the stack structure of the organic film/transparent electrode function as a light extraction structure. Thus, in the following description, a method of directly processing the high-refractive-index transparent layer 10 to form the light extraction structure 7 is described in detail, but another method described herein may be used.

The light extraction structure 7 has a shape protruding at least in a light extraction direction, and a cross-sectional shape thereof may be a triangle, a trapezoid, a polygon, or a combination thereof. When such a structure is present, in the case where light of a high-angle radiation component, which is not extracted onto a pixel, enters, the light at an arbitrary angle can be variously intensified by varying a light angle through use of internal reflection. Simultaneously, the light extraction efficiency is also enhanced. In particular, the light extraction structure 7 having a cross-section in the shape of an isosceles triangle with an apex angle of 120° to 135° can effectively enhance the light extraction efficiency of front luminance. In the present invention, the light extraction structure 7 in which two base angles are about 25° can further enhance the front luminance, and hence, the present invention is preferably applied to a display. Accordingly, the light extraction efficiency of the organic EL device, which is generally considered to be about 20%, is enhanced remarkably. Further, it is desired that the ring-shaped light extraction structure 7 be disposed so as to surround each outer circumference of the subpixels 1, 2, and 3 in the case where the subpixels 1, 2, and 3 have a circular shape.

No particular limitation is imposed on a method of producing the light extraction structure 7 and the structure having an intended shape to be produced on the support substrate in advance. For example, a resist pattern is formed on a film of SiNₓ or the like by photolithography, and after that, the resist pattern is subjected to dry etching to form intended structure. Alternatively, an intended mold pattern is transferred onto SiN by nanoimprinting, and after that, SiNₓ is processed by dry etching.

When the light extraction structure 7 is provided on the inter-subpixel region 5 between the subpixels 2 and 3 in the pixel 4, light emitted from the subpixels adjacent to the inter-subpixel region 5 propagates through the high-refractive-index transparent layer 10 and enters the subpixels 2 and 3 to be extracted. However, color mixing caused by the light extraction structure 7 in the pixel 4, for example, color mixing among blue, green, and red is additive color mixing of gradation-controlled colors, and hence, has no effect on the control for obtaining intended chromaticity. The color mixing rather has an advantage in that light propagating to the adjacent subpixels 2 and 3 can be extracted, and hence, the light extraction efficiency is enhanced.

On the other hand, emission colors from the subpixels, which are separately controlled for gradation, are to be mixed from the light extraction structure 7 provided on the inter-pixel region 6. For example, color mixing of a red subpixel 3 and a blue subpixel 1 which are included in the different pixels 4 and are adjacent to each other with the inter-pixel region 6 interposed therebetween ends up becoming additive color mixing which is not intended, because the gradation control of each subpixel is not matched with an emission color intended to be extracted. Thus, light of the unintended additive color mixing is extracted.

Here, MacAdam ellipses is considered as an example. A green color is not sensitive to chromaticity deviation, compared with red and blue colors, and a blue color is very sensitive to chromaticity deviation. Thus, blur in a displayed image is described by way of an example of the blue subpixel 1 having a blue emission color in the configuration of FIGS. 1A and 1B. The intrusion of light from a subpixel controlled for gradation having a different emission color to the blue subpixel 1 leads to chromaticity deviation of blue. In this case, the blue subpixel 1 emits light at intended chromaticity, whereas emitted light extracted from the light extraction structure 7 on the inter-pixel region 6 adjacent to the blue subpixel 1 has an emission color with chromaticity deviation, in which the color of the red subpixel 3 adjacent to the inter-pixel region 6 is mixed. Therefore, although a color close to a predetermined blue color is recognized on the blue subpixel 1, a color different from the predetermined blue color is recognized on the inter-pixel region 6. The blue subpixel 1 is recognized to have an emission color mixed with a red color, and hence, the color from the blue subpixel 1 is blurred. Further, in the inter-pixel region 6, chromaticity deviation with respect to predetermined gradation control on a pixel basis for displaying an image occurs, which leads to blur of an edge portion of a displayed image. When the blue subpixel 1, the red subpixel 3, and the green subpixel 2 are arranged in this order in the pixel 4, color mixing of the blue subpixel 1 and the green subpixel 2 adjacent to each other with the inter-pixel region 6 interposed therebetween occurs in the inter-pixel region 6.

Accordingly, in a display apparatus in which the high-refractive-index transparent layer 10 is incorporated so as to enhance the light extraction efficiency, light propagates for a long distance laterally in the high-refractive-index transparent layer 10, and consequently, emitted light reaches an adjacent pixel to cause blur.

In the present invention, in order to prevent blur in a displayed image, the width of the inter-pixel region is set to be equal to or larger than the waveguide length of light. Herein, the waveguide length is defined as a distance at which light emitted from the emission layer laterally propagates through the high-refractive-index transparent layer 10 while being totally reflected and attenuated at an interface between the high-refractive-index transparent layer 10 and an air layer, and the luminance of the light approaches zero. The luminance approaching zero means that the intensity of light is attenuated to 1% or less of luminance at a light-emitting point. The waveguide length is determined by a number of factors such as the structure and material of the organic EL device (for example, a reflectivity of the reflective electrode and an absorption coefficient of an organic layer).

A first factor includes the refractive index and the absorption coefficient of the high-refractive-index transparent layer 10 with respect to a wavelength of light propagating through the high-refractive-index transparent layer 10. In particular, the absorption coefficient remarkably influences the waveguide length. This is because the propagating light passes through the high-refractive-index transparent layer 10 multiple times while being totally reflected, and hence, the propagating light is greatly attenuated despite a small absorption coefficient of the high-refractive-index transparent layer 10, with the result that the waveguide length is shortened.

A second factor includes the shape, a refractive index, and number density of the light extraction structure 7 provided on the high-refractive-index transparent layer 10. The function of the light extraction structure 7 is to prevent light from being totally reflected to return to a high-refractive-index transparent layer 10 side when the light is output from the high-refractive-index transparent layer 10 to an air side, and thereby, extract the light to the air side. Accordingly, in the case where the number density of the light extraction structure 7 is small, the number of times per unit distance, at which light collides with the light extraction structure 7, decreases. Consequently, the frequency at which the light is totally reflected to the high-refractive-index transparent layer 10 without being extracted to the air side rises to increase the waveguide length. The waveguide length is changed also by the shape of the light extraction structure 7.

It is also possible to calculate a state in which the propagating light is attenuated in optical simulation by a calculator using the above-mentioned main factors. Examples of the optical simulation include a ray tracing method and a finite difference time domain (FDTD) method. According to the optical simulation, there is a limitation to a calculatable range of, for example, the film thickness of the high-refractive-index transparent layer 10 and the size of the light extraction structure 7. Therefore, the waveguide length cannot be always calculated with the light extraction structure 7 or device structure in an arbitrary shape.

In the present invention, a waveguide length is obtained by an experiment. The method of obtaining a waveguide length in the present invention is described specifically with reference to FIG. 5. The high-refractive-index transparent layer 10 is considered, which includes, on the support substrate 9, the organic compound layers 16, 17, and 18 each including an emission layer and the light extraction structures 7 provided on the organic compound layers 16, 17, and 18. The front emission luminance of a partition line 52 between a current-carrying region and a non-current-carrying region is normalized to be 1, with a circular light-emitting region 51 as a target. Light indicated by an arrow in FIG. 5 is output to an air layer side or absorbed by the light extraction structure 7 to be attenuated while propagating through the high-refractive-index transparent layer 10, and the luminance of the light eventually approaches zero. Experimentally, a light extraction structure 8 having the same shape as that of the light extraction structure 7 is provided as a detector for detecting light intensity on the high-refractive-index transparent layer 10 at an arbitrary distance from the light extraction structure 7 on the right side in FIG. 5. Then, by observing the intensity of output light at the light extraction structure 8, a distance at which the luminance of the light approaches zero, that is, a distance at which the intensity of the light is attenuated to 1% of the front emission luminance of the partition line 52, can be obtained. This distance is defined as a waveguide length (L).

In a display apparatus including an organic EL device, for example, the light-emitting regions as illustrated in FIG. 1B, that is, the subpixels 1, 2, and 3 are disposed respectively for a blue color, a green color, and a red color. For example, a waveguide length is obtained for the subpixel of each color, and the waveguide lengths of blue light, green light, and red light are represented by L_{E}, L_{G}, and L_{R}. In the case where the red subpixel 3 in a first pixel and the blue subpixel 1 in a second pixel are disposed adjacently to each other (so as to be closest to each other), in order to prevent blur in a displayed image, the distance between the subpixels 1 and 3 only needs to be set to be larger than the sum of the waveguide length (L_{R}) of light from the red subpixel 3 and the waveguide length (L_{E}) of light from the blue subpixel 1. However, when the distance between the subpixels 1 and 3 is set to be large, the resolution of the display apparatus is degraded, and hence, it is more preferred that the sum of the waveguide length of light from the red subpixel 3 and the waveguide length of light from the blue subpixel 1 be equal to the distance between the subpixels 1 and 3.

A circuit, wiring, and the like for driving the display apparatus of the present invention are not particularly defined, and may be designed and provided, as necessary, for obtaining intended performance.

Further, in the display apparatus of the present invention, the light extraction structure is used for extracting light confined in the device outside, and the light extraction structure may be further sealed with sealing glass such as a glass cap or sheet glass. A color filter for improving chromaticity and a circularly polarizing plate for reducing the reflection of ambient light may be provided on the sealing glass.

Hereinafter, specific examples of the present invention are described.

### Example 1

As Example 1, a display apparatus having a configuration in which an organic EL device had a cross-sectional structure of FIG. 4, and pixels, subpixels, and light extraction structures were laid out as illustrated in FIG. 2B was produced by the following method. Specifically, the display apparatus of this example includes a plurality of pixels, and each pixel includes subpixels of a plurality of colors (blue subpixel 1, green subpixel 2, red subpixel 3), each subpixel having an organic EL device.

In this example, first, a TFT drive circuit (not shown) made of low-temperature polysilicon was formed on a glass substrate, and a flattening film (not shown) made of an acrylic resin was formed on the TFT drive circuit to obtain a support substrate 9. Next, as a reflective electrode 22, an Ag alloy was formed on the support substrate 9 by sputtering so as to have a film thickness of about 150 nm. The reflective electrode 22 made of an Ag alloy was a highly reflective film having a spectral reflectivity of 80% or more in a visible light wavelength region (λ=380 nm to 780 nm). Further, a film of ITO was formed as a transparent electrode 23 by sputtering. After that, a polyimide-based resin was spin-coated as a bank 15 as illustrated in FIG. 3, and openings (circular openings having a diameter of 27 μm) were provided at intended positions by photolithography to obtain subpixels to be light-emitting regions.

After that, respective organic compound layers were successively formed and stacked by vacuum deposition. In the display apparatus of this example, in each of the subpixels 1, 2, and 3, the film thickness of a hole transport layer 25 was changed so that the optical film thickness from an emission layer 26 to the reflective electrode 22 corresponded to ¾ of each emission color wavelength. Regarding a blue color, a fluorescent material was used as a light-emitting dopant in the emission layer 26, and regarding green and red colors, a phosphorescent material, which is expected to exhibit higher internal quantum efficiency, was used as the light-emitting dopant in the emission layer 26. The refractive index of a layer having the highest refractive index in the organic compound layers of each subpixel was 1.86 in a blue subpixel, 1.80 in a green subpixel, and 1.78 in a red subpixel.

Next, a film of IZO was formed as a transparent electrode 20 by sputtering. Then, a silicon nitride (SiN) film was formed to have a thickness of 4.3 μm by CVD. The refractive index of the SiN film was 1.89 in a wavelength of 450 nm (blue region), 1.88 in a wavelength of 520 nm (green region), and 1.86 in a wavelength of 620 nm (red region). Thus, the refractive index in any subpixel was higher than those of the organic compound layers. Hexamethyldisilazane was spin-coated on the SiN film to modify the surface, and thereafter, a photoresist (AZ1500) was spin-coated to obtain a film having a film thickness of about 3.3 μm. The photoresist was exposed to light by photolithography through use of a mask aligner (MPA-600FA). Then, the exposed photoresist was developed with a developer (AZ312MIF) to obtain a resist pattern. Post-baking was conducted at 100° C. for 3 minutes. The SiN film was etched together with the resist pattern by dry etching using carbon tetrafluoride and oxygen, to thereby form a light extraction structure 7 having a ring shape surrounding the subpixel. In a final configuration, ring-shaped structure as the light extraction structure 7 was formed on a high-refractive-index transparent layer 10 having a refractive index higher than those of the organic compound layers and a film thickness of 1.0 μm, and the height of the ring-shaped structure was 3.3 μm. Further, the width of the bottom surface of the ring-shaped structure was 11.5 μm, the cross-sectional shape of the ring-shaped structure was a triangle with an apex angle of 120°, and an inner bottom angle and an outer bottom angle of the ring-shaped structure were 30°.

In such device structure, the waveguide length was experimentally obtained as described above. When the state of light emitted from the red subpixel was observed with an optical microscope, it was found that, the luminance decreases as the distance from a partition line between a current-carrying region and a non-current-carrying region increases, and light is eventually attenuated completely and cannot be visually recognized. Light emitted from another subpixel (green and blue subpixels) was also observed by the same method, and the waveguide lengths thereof from the partition line were measured.

The waveguide length thus measured was 30 μm in the red subpixel, which was the longest, 13 μm in the green subpixel, and 7 μm in the blue subpixel, which was the shortest. Although the ring-shaped structure as the light extraction structure 7 merely surrounds the subpixel in a loop shape, the emission intensity has already decreased to about 1/10 in the outer circumference of the ring-shaped structure, compared with the case where no ring-shaped structure is present. Specifically, this result shows that the ring-shaped structure has a high light extraction effect and can efficiently extract light guided through the high-refractive-index transparent layer 10 to the air side, and hence, the guided light is reduced largely at a time when the light has passed through the ring-shaped structure and the waveguide length is shortened. Further, the waveguide length varies depending on the color because SiN used in the high-refractive-index transparent layer 10 has a different absorption coefficient for each color. Specifically, SiN does not exhibit absorption with respect to red light, whereas SiN exhibits larger absorption as the wavelength becomes shorter from green light to blue light.

In the pixel layout as illustrated in FIG. 2B, for example, a blue subpixel 1 belonging to a pixel 4a is focused on. In this case, subpixels closest to the blue subpixel 1, belonging to pixels different from the pixel 4a, include four subpixels: a green subpixel 2 and a red subpixel 3 belonging to a pixel 4b, a green subpixel 2 belonging to a pixel 4c, and a red subpixel 3 belonging to a pixel 4d.

Therefore, in order to prevent blur from occurring by color mixing between subpixels belonging to different pixels, the following setting is performed. Specifically, the distance between the blue subpixel 1 and the red subpixel 3 included in different pixels is set to be at least 37 μm which is a sum of the waveguide length of blue light and the waveguide length of red light. Further, the distance between the blue subpixel 1 and the green subpixel 2 is set to be at least 20 μm which is a sum of the waveguide length of blue light and the waveguide length of green light. It is desired that the resolution of the display apparatus be higher, and hence, the distance between the blue subpixel 1 and the red subpixel 3 included in different pixels may be set to be the sum of the waveguide lengths (for example, 37 μm), and the distance between the blue subpixel 1 and the green subpixel 2 may be set to be the sum of the waveguide lengths (for example, 20 μm).

Further, in the case where it is desired that the distances between subpixels of respective colors be all equal to each other, pixels only need to be arranged with an inter-subpixel distance set to be 43 μm which is the largest sum of waveguide lengths of all the combinations of waveguide lengths. In this example, a display apparatus was produced by way of trial with all the inter-subpixel distances in the pixels and between the adjacent pixels set to be 43 μm.

In order to check the degree of blur in the display apparatus thus produced, a human image was displayed against the background of the blue sky, and an emission color of a contour portion in a white site such as the skin was checked. In the contour portion of the human in the displayed image obtained in this example, no change in an emission color derived from blur was found.

Further, in this example, the light extraction efficiency was enhanced about twice and the front luminance was enhanced about three times, compared with the case where no ring-shaped extraction structure was provided. An increase in the emission intensity was found mainly in a front direction in which light was emitted.

### Comparative Example 1

A display apparatus with the same configuration as that of Example 1 was produced by a production process similar to that of Example 1 with the exception that all the inter-subpixel distances were set to be 20 μm. When the degree of blur in the obtained display apparatus was checked in the same way as in Example 1, a change in an emission color derived from blur was found in a contour portion of a human in a displayed image, and a violet blur was visually recognized in the contour portion. On the other hand, the light extraction efficiency was enhanced about twice and the front luminance was enhanced about three times, compared with the case where no ring-shaped structure as the light extraction structure 7 was provided. An increase in emission intensity was found mainly in a front direction in which light was emitted.

### Example 2

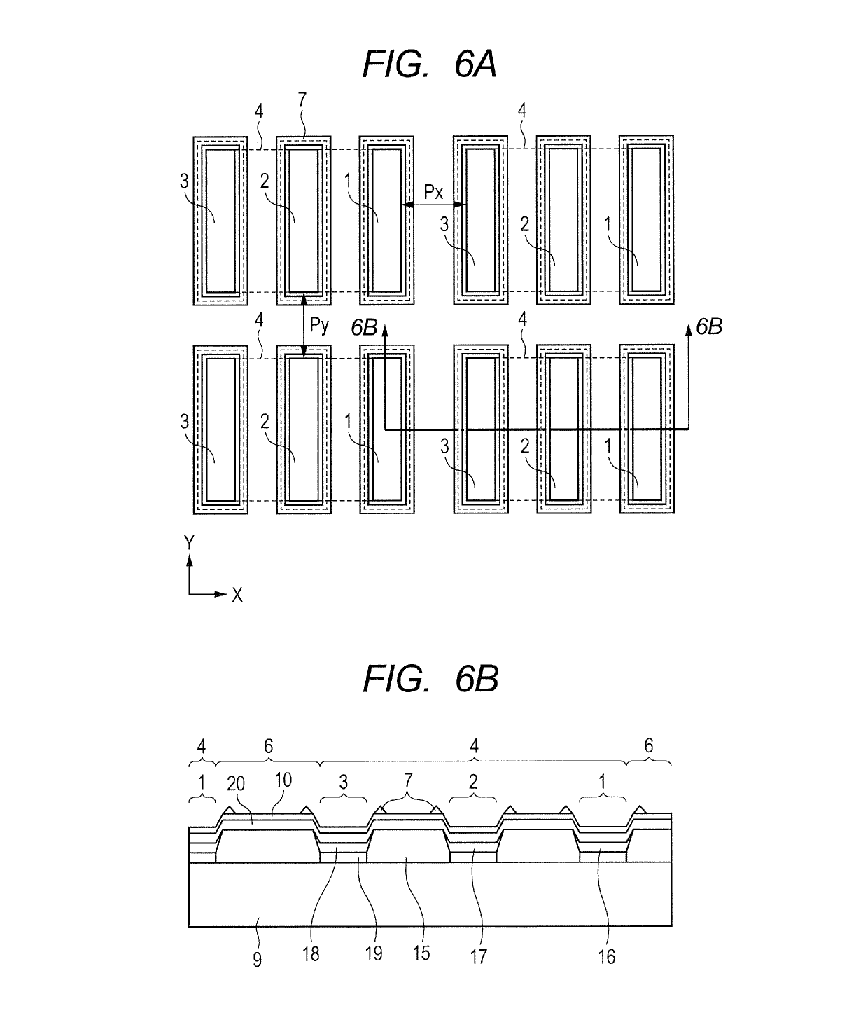

As Example 2, a display apparatus with the same configuration as that of Example 1 was produced by way of trial by a method similar to that of Example 1 with the exception that a rectangular stripe-shaped pixel layout was disposed, and a light extraction structure 7 was disposed so as to surround the outer circumference of each subpixel, as illustrated in FIGS. 6A and 6B. FIG. 6A is a schematic top view of this example, and FIG. 6B is a schematic cross-sectional view taken along line AB of FIG. 6A. In the light extraction structure 7 to be finally obtained, ring-shaped structure having a height of 3.3 μm and a bottom surface with a width of 11.5 μm was formed as the light extraction structure 7 on a high-refractive-index transparent layer 10 having a film thickness of 1.0 μm in the same way as in Example 1.

In the pixel layout illustrated in FIGS. 6A and 6B, for example, a red subpixel 3 in a pixel 4 on the upper right side of the drawing sheet is focused on. In this case, subpixels closest to the red subpixel 3, belonging to pixels different from the pixel 4, include three subpixels: a blue subpixel 1 belonging to a pixel on the upper left side of the drawing sheet, a red subpixel 3 belonging to a pixel on the lower side of the drawing sheet, and a red subpixel belonging to a pixel on the upper side of the drawing sheet (not shown).

The waveguide length of each color was obtained in the same way as in Example 1 in the rectangular pixel layout, and consequently, the waveguide length was longest in red light and became shorter from green light to blue light. In the layout in which the red subpixel 3 for emitting light having the longest waveguide length was disposed on the left end of the pixel, an inter-pixel distance Pₓ between the red subpixel 3 and the blue subpixel 1 belonging to the pixel on the left side of the red subpixel 3 is set to be equal to or larger than the sum of the waveguide length of light emitted from the blue subpixel 1 and the waveguide length of light emitted from the red subpixel 3. Thus, blur derived from color mixing can be prevented. However, with this configuration, the inter-pixel distance P, becomes large, which is not preferred from a viewpoint of the resolution of the display apparatus.

By placing the red subpixel 3 for emitting light having the longest waveguide length at the center of the pixel 4, the inter-pixel distance Pₓ in the lateral direction can be shortened by the distance between the red subpixel 3 and the blue subpixel 1 and the distance between the red subpixel 3 and the green subpixel 2 belonging to the same pixel 4. This configuration is preferred from a viewpoint of the resolution of the display apparatus. When the red subpixel 3 was actually disposed at the center of the pixel, even in the case where the inter-pixel distance Pₓ was set to be less than 37 μm, there was no particular problem as long as the inter-pixel distance Pₓ was at least 20 μm, and a display apparatus without blur was obtained. Note that, regarding an inter-pixel distance P_{y}, the red subpixels 3 are adjacent to each other, and hence, it is preferred that the inter-pixel distance P_{y} be at least 60 μm which is at least twice the waveguide length of light from the red subpixel 3.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-212117, filed Sep. 28, 2011, which is hereby incorporated by reference herein in its entirety.

What is claimed is:

1. A display apparatus, comprising a plurality of pixels each including a plurality of subpixels for emitting light having different emission colors,
each of the plurality of subpixels including an organic EL device which includes a first electrode, a second electrode, and an organic compound layer including an emission layer disposed between the first electrode and the second electrode, wherein:
the organic EL device includes, on a light exit side thereof, a transparent layer having a refractive index higher than a refractive index of the organic compound layer;
the transparent layer includes a light extraction structure provided outside of each of the plurality of subpixels; and
a distance between subpixels closest to each other included in two adjacent pixels is set to be at least a sum of waveguide lengths of light emitted from the two subpixels closest to each other included in the two adjacent pixels.

2. The display apparatus according to claim 1, wherein:
the plurality of subpixels included in one of the plurality of pixels include a subpixel for emitting blue light, a subpixel for emitting red light, and a subpixel for emitting green light;
the subpixel for emitting blue light, the subpixel for emitting red light, and the subpixel for emitting green light are formed in a stripe shape; and
of the subpixel for emitting blue light, the subpixel for emitting red light, and the subpixel for emitting green light, a subpixel for emitting light of an emission color having a longest waveguide length is disposed at a center of the pixel.

3. The display apparatus according to claim 2, wherein the subpixel for emitting light of the emission color having the longest waveguide length comprises the subpixel for emitting red light.

4. The display apparatus according to claim 1, wherein the plurality of pixels each have a triangular shape.

5. The display apparatus according to claim 1, wherein the light extraction structure has a protruding shape on the light exit side.

6. The display apparatus according to claim 1, wherein:
a cross-section of the light extraction structure is a triangle; and
an apex angle of the triangle is 120° or more and 135° or less.

7. The display apparatus according to claim 6, wherein the triangle is an isosceles triangle.

8. The display apparatus according to claim 1, wherein the light extraction structure is formed so as to surround each of the plurality of subpixels.

9. The display apparatus according to claim 1, wherein the light extraction structure is formed of a plurality of conical structures.

10. The display apparatus according to claim 1, wherein the light extraction structure is formed of a ring-shaped structure in which conical structures are integrated in a loop shape.

11. The display apparatus according to claim 1, wherein a light transmittance of the transparent layer is at least 85% in a visible light region.

12. The display apparatus according to claim 1, wherein the transparent layer includes at least one of silicon nitride, titanium oxide, and zinc oxide.

13. The display apparatus according to claim 1, wherein the transparent layer has a film thickness of 0.5 μm or more and 6.0 μm or less.

14. The display apparatus according to claim 1, wherein the transparent layer has a film thickness of 0.5 μm or more and 1.0 μm or less.
